(19) United States
(12) Patent Application Publication
(10) Pub. No.: US 2011/0019215 A1
(43) Pub. Date: Jan. 27, 2011

(54) PRINT CHARACTER SELECTOR OF PRINTER AND ASSEMBLING METHOD OF OPERATING MEMBER OF THE PRINT CHARACTER SELECTOR

(76) Inventor: Koichi Shimosaka, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/921,586

(22) PCT Filed: Dec. 1, 2008
(86) PCT No.: PCT/JP2008/071772

§ 371 Date: Sep. 9, 2010

(30) Foreign Application Priority Data
Mar. 28, 2008 (JP) 2008-088210

(51) Int. Cl. G06K 15/02; B23P 19/00

(52) U.S. Cl. 358/1.11; 29/428

(57) ABSTRACT

To provide a print character selector of a printer and assembling method of operating member of the print character selector which configures both the axial direction regulation mechanism for the indexing regulation of the selector wheel 6 and the rotational direction regulating mechanism for the selection regulation of the print character of the endless print band 8 at the knob shaft 16.

The print character selector includes a plurality of regulating recesses at a periphery of the knob shaft of the operating member (5) both in axial and rotational directions of the shaft. An urging member for regulation engages and disengages from the regulating recesses. A plurality of regulating recesses (16A) capable of selecting any one of the selector wheels (6) by moving the knob (15) along the axial direction, and configured for selecting any one of the print characters by rotating the knob around the axial direction are provided on the knob shaft. The urging member for regulation engages and disengages from the regulating recesses.

### CROSS REFERENCE TO RELATED APPLICATION

The present application is a 35 U.S.C. §§371 national phase conversion of PCT/JP2008/071772, filed Dec. 1, 2008, which claims priority of Japanese Patent Application No. 2008-088210, filed Mar. 28, 2008, the content of which is incorporated herein by reference. The International Application was published in the Japanese Language.

### TECHNICAL FIELD

The present invention relates to a print character selector of a printer and to an assembly method of an operating member of the print character selector. More particularly, the present invention relates to a print character selector of a printer and an assembly method of an operating member of the print character selector which is mounted on a portable printing and labeling device.

### BACKGROUND ART

A conventional print character selector of a printer, as shown in patent document 1 (Japanese Patent Publication No. 368336), for example, is provided with a printer frame, an operating member, a plurality of selector wheels disposed adjacent each other in a coaxial direction, and a plurality of endless printing bands each engaging to a respective selector wheel and each having print characters.

The conventional print character selector of a printer is provided with an operating shaft as the above operating member. By moving the operating shaft in an axial direction of the selector wheels, the conventional print character selector of the printer selects any one of the selector wheels (row selection), then selects any one of the endless printing bands located at any one of the rows or the columns (the so-called indexing operation), and also selects the print characters on the endless printing bands (the print character selection) by rotation of the operating shaft.

Therefore, there is a need for an axial direction regulating mechanism for clearly conveying indexing regulation (the feeling or touch of the fingers at the time of row selection) to the fingers of the operator performing the row indexing operation of the selector wheel by moving the above operating member in the axial direction, and a rotational direction regulating mechanism for clearly conveying the rotation regulation (feeling of proper setting states of the individual print characters or distinction between the set states) of the respective print characters felt by the fingers of the operator when selecting the printing character of the endless printing band by rotating the above-mentioned operating member.

However, in a conventional print character selector of a printer, the above axial direction regulating mechanism and rotational direction regulating mechanism are provided separately and that causes a problem that it is not possible to avoid, namely complication of the configuration and increment of the number of parts.

Furthermore, the endless printing bands are set around the selector wheel portion of the operating shaft located at the upper portion of the printer and receive the regulating block or the print pressure bearing base portion located at the lower portion of the printer which actually performs printing by stamping operation.

A mechanism which attempts to maintain the rotational regulation at selection of the print character of the endless print band by only the spring force of the regulating block or the print pressure bearing base portion has a weak regulating feeling. Also, as the rotational regulation is produced at the regulating block which is away from the operating shaft, this causes a problem that the certainty of the operation feeling is low.

Obviously, a problem is that it requires many processes to assemble the axial direction regulating mechanism and the rotational direction regulating mechanism respectively.

### SUMMARY OF INVENTION

### Technical Problem

The present invention has been made in view of the aforementioned problem. The object of the present invention is to provide a print character selector of a printer and an assembling method of an operating member of the selector which can simplify both the axial direction regulating mechanism for the indexing regulation of the selector wheel and the rotational direction regulating mechanism for the selection regulation of the print character of the endless print band.

Another object of the present invention is to provide a print character selector of a printer and an assembling method of an operating member which can configure the axial direction regulating mechanism and the rotational direction regulating mechanism necessary for selecting the rows and print characters of the endless print bands at the knob shaft portion of the operating member.

Another object of the present invention is to provide a print character selector of a printer and an assembling method of an operating member which can reduce the number of parts.

Another object of the present invention is to provide a print character selector of a printer and an assembling method of an operating member, which can equip the operating member with both a configuration to obtain an indexing regulation for the selecting operation of the selector wheel itself, and a configuration to obtain a rotational regulation, while also simplifying the configuration and improving the feeling (or touch) of the operator's hands at time of print character selection.

Yet another object of the present invention is to provide a print character selector of a printer and assembling method of operating member which can simplify the assembling process and improve the work efficiency without increment of the parts.

### Solution to Problem

In order to solve the aforementioned problem, the present invention focuses on providing a plurality of regulating recesses at a periphery of the knob shaft of the operating member both in the axial and rotational directions of the shaft, and providing an urging member for regulation engaging with and disengaging from these regulating recesses on a printer frame.

A first aspect of the present invention includes: a print character selector of a printer having a printer frame, selector wheels lying side by side and overlapping coaxially with each other and rotatable around an axial direction inside the printer frame, an operating member which selects any one of the selector wheels in the axial direction and which can rotationally drive any one of the selected selector wheel around the axis, a plurality of endless print bands each formed with a plurality of print characters on the peripheries, and each engaged to outer peripheral engaging grooves of the selector wheels, the print character selector of a printer comprising: a sleeve supporting the selector wheels rotatably, and forming a selection window extending in the axial direction; and, the operating member having: a knob capable of moving along the axial direction of the selector wheels and rotating around the axial direction; a knob shaft operable by the knob both in a reciprocable and a rotatable manner inside the sleeve, and provided with drive projections capable of rotationally driving the selector wheels by engaging inner peripheral grooves of the selector wheels through the selection window of the sleeve; a plurality of regulating recesses capable of selecting any one of the selector wheels by moving the knob along the axial direction, and capable of selecting any one of the print characters by rotating operation of the knob around the axial direction are formed; and an urging member for regulation provided on the printer frame which is engaged and disengaged to and from the regulating recesses.

A second aspect of the present invention relates to a method of assembling an operating member of a print character selector of a printer having a printer frame, selector wheels lying side by side and overlapping coaxially with each other and rotatable around an axial direction inside the printer frame, an operating member which selects any one of the selector wheels in the axial direction and which can rotationally drive any of the selected selector wheels around the axis, a plurality of endless print bands each formed with a plurality of print characters on their peripheries, and each engaged to outer peripheral engaging grooves of the selector wheels, the operating member having: a knob capable of moving along the axial direction of the selector wheels and rotating around the axial direction; a knob shaft operable by the knob and provided with driving projections engaging the inner peripheral grooves of the selector wheels to rotationally drive the selector wheels; a display frame capable of moving with the knob shaft in an integrated manner in the axial direction of the selector wheel, and extending in the axial direction; a selector wheel rotation restricting rod capable of moving with the knob shaft in an integrated manner in the axial direction of the selector wheel, and extending in the axial direction; the knob shaft being formed with a plurality of regulating recesses capable of selecting any one of the selector wheels by moving the knob along the axial direction, and capable of selecting any one of the print characters by rotating the knob around the axial direction; and, an indicator formed by integrating the display frame and the selector wheel rotation restricting rod; and, the method of assembling an operating member of a print character selector of a printer comprising: an urging member setting process which sets the urging member for regulation to an urging member setting hole formed on the printer framed adjacent to the knob; a shaft inserting process which inserts the knob shaft into a shaft attachment hole on the printer frame such that the urging member for regulation is engageable and disengageable to and from the regulating recesses; an indicator assembling process which assembles the indicator to an assembling end of the knob shaft; and a knob assembling process which assembles the knob to the assembling end of the knob shaft.

A third aspect of the present invention relates to the regulating recesses of the knob shaft which are formed on the knob shaft at positions corresponding each of the selector wheels, and along the rotating direction of the selector wheels.

A fourth aspect of the present invention relates to the urging member for regulation, which are a coil spring and a steel ball set inside an urging member setting hole formed on the printer frame adjacent to the knob, and the steel ball is capable of engaging with and disengaging from each of the regulating recesses.

A fifth aspect of the present invention relates to the operating member provided with a display frame capable of moving with the knob shaft in an integrated manner in the axial direction of the selector wheels, and extending in the axial direction.

A sixth aspect of the present invention relates to the operating member provided with a selector wheel rotation restricting rod capable of moving with the knob shaft in an integrated manner in the axial direction of the selector wheels, and extending in the axial direction. The selector wheel rotation restricting rod has a rotation allowing recess, which enables only the selector wheel selected out of all of the selector wheels by the operation member to rotate, and a rotation restricting projection which enables the rotation of the unselected selector wheels to be restricted.

A seventh aspect of the present invention relates to the rotation restricting projection of the selector wheel rotation restricting rod which is engageable with the outer peripheral engaging grooves of the selector wheels.

An eighth aspect of the present invention relates to the urging member setting hole and the shaft attachment through-hole formed in a manner crossing each other.

A ninth aspect of the present invention relates to a plurality of regulating recesses formed on the knob shaft which are recesses also for obtaining regulation in the axial and the rotational directions, and the urging member for regulation are engaged with and disengaged from those recesses.

### ADVANTAGEOUS EFFECTS OF INVENTION

In the print character selector of a printer and the assembly method of the operating member of the selector according to the present invention, a plurality of regulating recesses are formed on the knob shaft. These enable the selection of any one of the selector wheels by moving the knob along an axial direction along the axes of the wheels, and this enables any one of the print characters to be selected on the knob shaft by rotating the knob around the axis. Since a print character selector of a printer is provided with the urging member for regulated engagement with and disengagement from the regulating recesses on the printer frame, both the axial direction regulating mechanism and the rotational direction regulating mechanism can be configured via these regulating recesses. It is therefore possible to reduce the number of parts, simplify the configuration, and improve the assembling work efficiency.

Particularly, according to the first aspect of the invention, since a plurality of regulating recesses are formed along the axial and the rotational directions on the knob shaft, by engaging and disengaging actions of each regulating recess and urging member for regulation, it is possible to obtain the axial direction regulation when selecting the selector wheel (endless print band) in the axial direction, and to also obtain the rotational direction regulation when selecting the print character of the endless print band in the rotational direction.

### BRIEF DESCRIPTION OF DRAWINGS

FIG. 1 is a cross-section diagram of a printer 1 equipped with a print character selector 2 according to an embodiment of the present invention.

FIG. 2 is a cross-section diagram of the printer 1 equipped with a print character selector 2 along line II-II in FIG. 1.

FIG. 3 is a side view diagram of the printer frame 3.

FIG. 4 is a cross-section diagram of the knob shaft 16 in the axial direction.

FIG. 5 is a cross-section diagram of the knob shaft 16 in a direction perpendicular to the axial direction.

FIG. 6 is a cross-section diagram of the printer frame 3 in FIG. 3 along the line VI-VI.

### DESCRIPTION OF EMBODIMENTS

Since the regulating recesses which can be used also to obtain regulation in the axial and the rotational directions are formed on the knob shaft, a print character selector of a printer and an assembling method of an operating member of the selector with a small number of parts, and in a simplified configuration is provided, and this achieves excellent work efficiency.

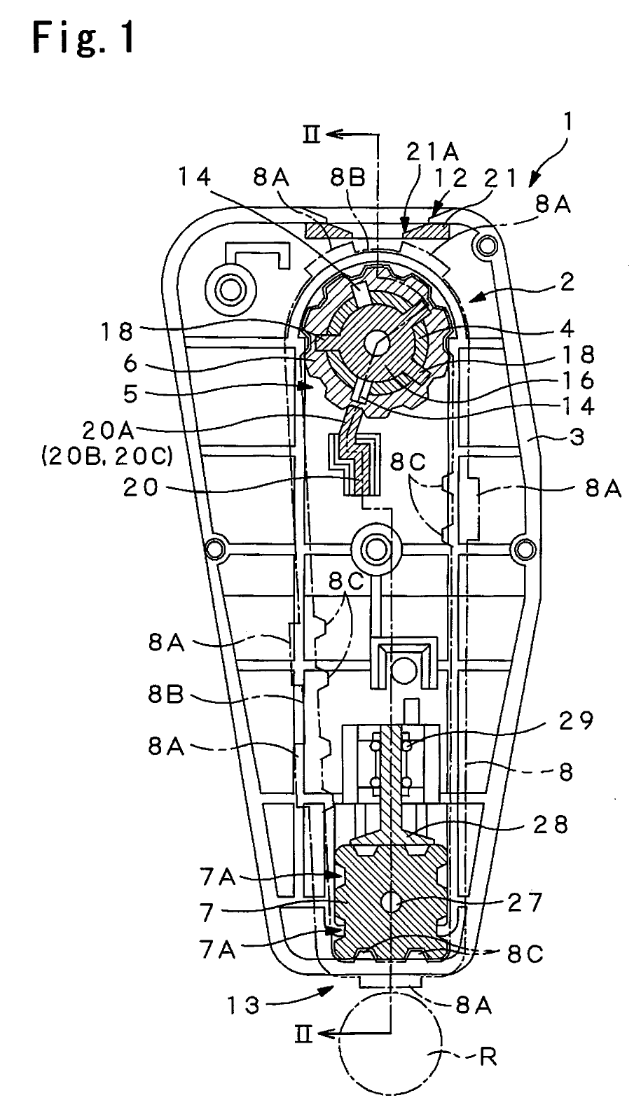

Hereinafter, a print character selector of a printer and an assembling method of the operating member of the print character selector that is an embodiment of the present invention are explained based on FIGS. 1 through 6.

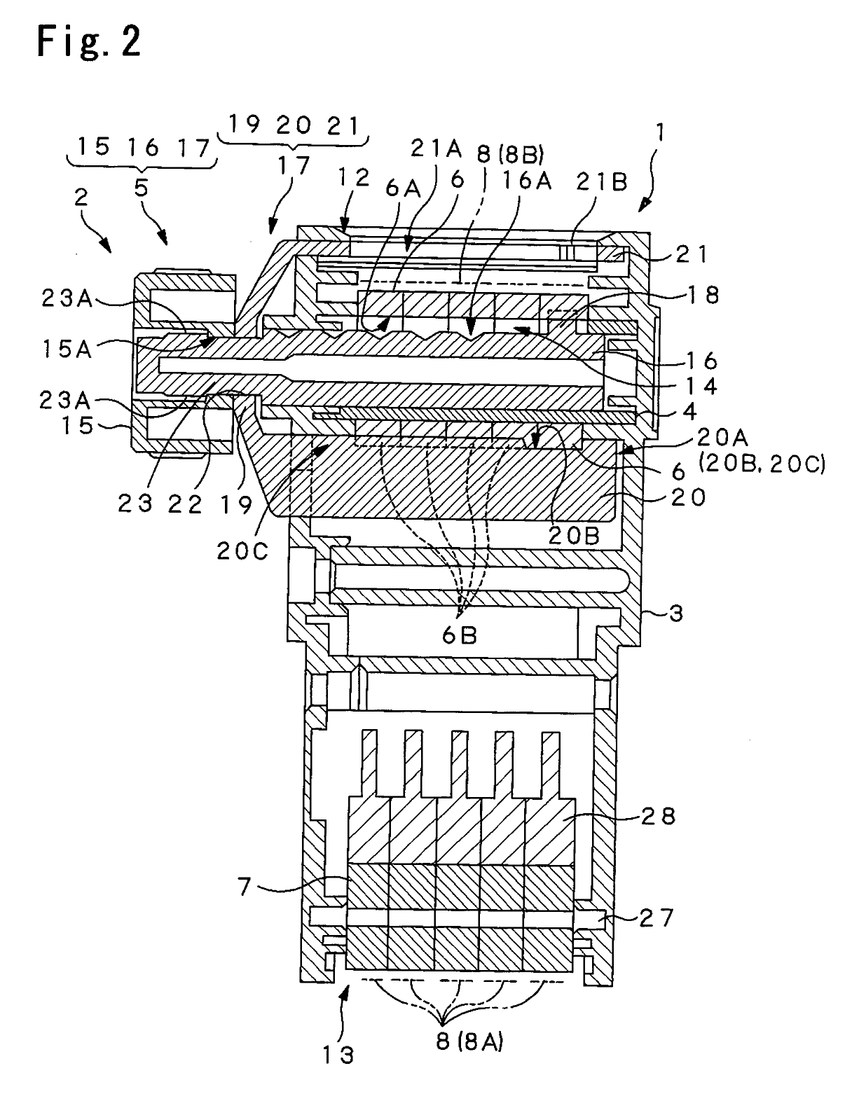

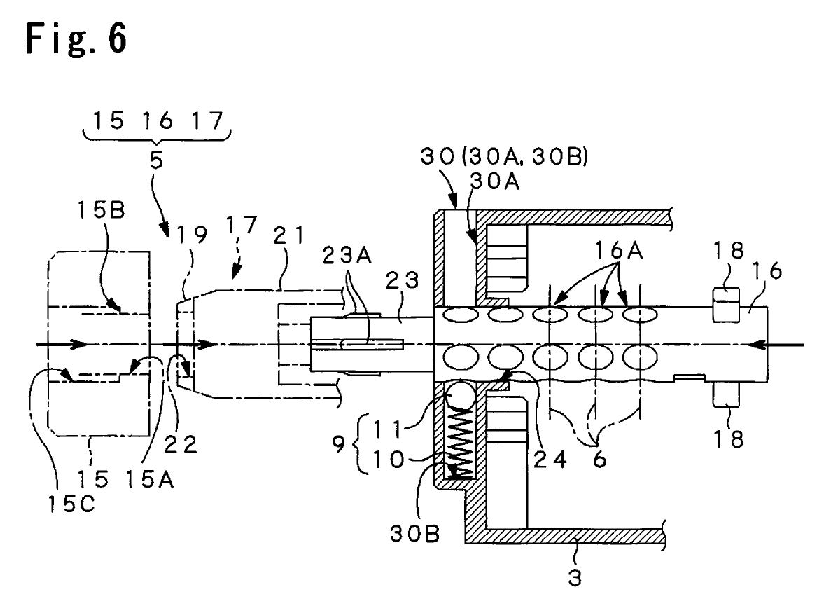

The printer 1 is provided with a print character selector 2, a printer frame 3, a cylindrical shape sleeve 4, an operating member 5 for print selection (in FIG. 2), plural rows of selector wheels 6 (five rows in the example in FIG. 2) lying side by side overlapping coaxially with each other and rotatable around their axis inside the printer frame 3, a print pressure bearing base-regulating block 7, plural rows of endless print bands 8 (five rows in the example in FIG. 2), and an urging member for regulation 9 (a coil spring for regulation 10 and a steel ball 11, referring to FIG. 6).

The print character selector 2 is provided with the printer frame 3, the sleeve 4, the operating member 5, the selector wheels 6, the print pressure bearing base-regulating block 7, the endless print bands 8, and urging member for regulation 9, etc.

Referring to FIG. 1, the printer frame 3 forms openings which are a display window 12 at its upper part and an ink roller access opening 13 at its lower portion respectively.

At the ink roller access opening 13, an ink roller R rotates in a manner enabling the roller to contact the print character 8A of the endless print band 8.

The sleeve 4 is provided rotatably inside the printer frame 3, forming, for example, five selection windows 14 long-extending in its axial direction. The sleeve 4, at its outer periphery, is supporting the selector wheels 6 and the sleeve is rotatable in an integrated manner with the selector wheels 6.

The operating member 5 selects any one of the selector wheels 6 in the axial direction of the selector wheels 6, and enables the selected selector wheel 6 to be driven rotationally around its axis. The operating member 5 is provided with a knob 15 (in FIG. 2) located outside the printer frame 3, a knob shaft 16 located at the center of the operating member 5 and is cylindrical in cross-section, and an indicator 17 which can be assembled to the knob shaft 16 in an integral manner together with the knob 15.

The knob 15 is a short cylindrical member assembled in an integral manner with the knob shaft 16 extending in the axial direction of the selector wheels 6. The knob 15 is capable of moving with respect to the printer frame 3 and the selector wheels 6 (endless print bands 8) along the axial direction of the selector wheels 6, and capable of rotation around the axis.

In the knob 15, there is a shaft attachment hole 15A for inserting the knob shaft 16 and also a step portion 15B for axial direction fixing and a key way 15C are formed (referring to FIG. 6).

The knob shaft 16 is operable by the knob 15 in both a reciprocable and a rotatable manner inside the sleeve 4. At its end portion (the most distant portion from the knob 15), the knob 16 is provided, for example, with three drive projections 18 projecting in the diametrical direction.

The drive projections 18 are capable of moving in the axial direction and then through the selection windows 14 of the sleeve 4 along the inner peripheral engaging grooves 6A formed on the inner periphery of the selector wheels 6, and the projections 18 are also capable of rotationally driving the selector wheels 6 together with the sleeve 4 by engaging the inner peripheral engaging grooves 6A.

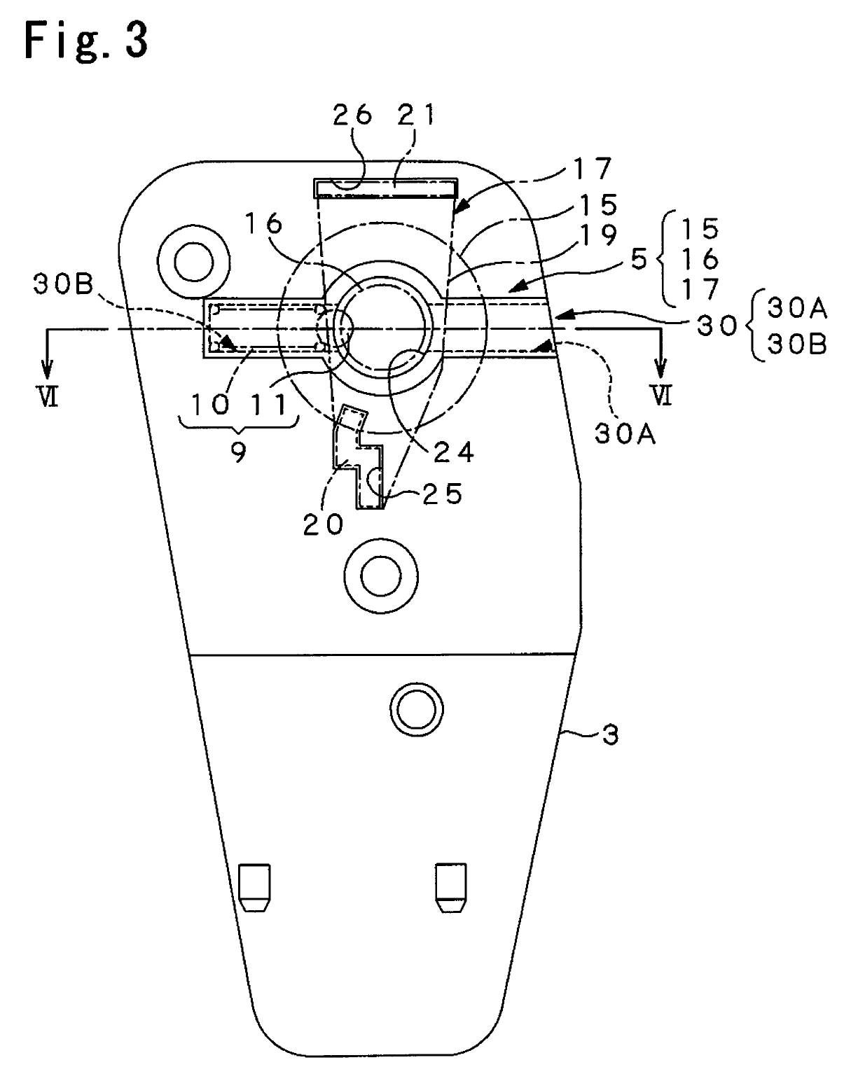

On the outer periphery of the knob shaft 16, there are a plurality of regulating recesses 16A which are capable of selecting any one of the selector wheels 6 caused by movement of the knob 15 along the axial direction, and are also capable of selecting any one of the print characters 8A by rotation of the knob 15 around its axis. The urging member for regulation 9 provided on the printer frame 3 (in FIGS. 3 and 6) is for engaging and disengaging the regulating recesses 16A.

The regulating recesses 16A of the knob shaft 16 are formed at positions corresponding to each selector wheels 6, and also along the rotation direction of the selector wheels 6.

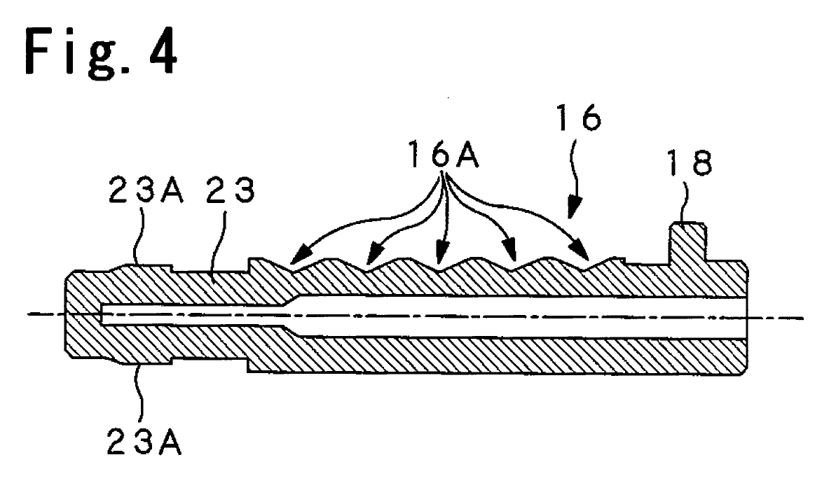

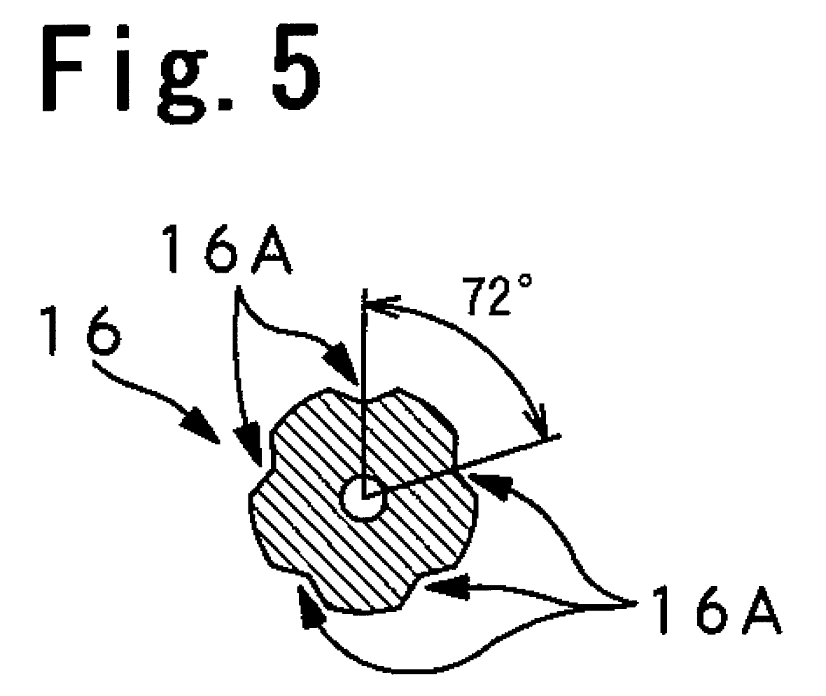

Specifically, as shown in FIGS. 4 and 5, a total of twenty-five regulating recesses 16A are formed, five in the axial direction corresponding to the number and the position of the selector wheels 6, and five equiangularly in the circumferential direction (in other words, the angles between each regulating recesses 16A are 72 degrees) corresponding to the rotating direction of the selector wheels 6 (and the endless print bands 8) respectively.

In addition, the circumferential angles between adjacent regulating recesses 16A are selected such that the distance corresponding to the circumferential angle corresponds to the distance between adjacent print characters 8A on the endless print band 8 when the endless print band 8 is rotated via the selector wheel 6. So when the knob shaft 16 rotates as much as this circumferential angle, the endless print band 8 moves as much as one print character 8A.

The indicator 17 is capable of moving in the axial direction with the knob shaft 16 and the selector wheels 6 in an integral manner, and extends in the axial direction of the selector wheels 6. The indicator 17 does not rotate in the rotating direction of the knob 15 and the knob shaft 16, but is capable of moving in the axial direction of the selector wheels 6 of the knob 15 and the knob shaft 16 in an integral manner. The indicator 17 is formed by a joining portion 19 in the central portion, a selector wheel rotation restricting rod 20 which is jagged in shape, e.g. lightning-shaped in cross-section, and located at the lower portion, and a flat-plate display frame 21 located at the upper portion, in an integral manner.

The joining portion 19 is formed with a shaft through-hole 22 in the center and can be assembled to the assembling end 23 of the knob shaft 16. At the assembling end 23, an engaging projection 23A is formed protrudingly.

Particularly, as shown in FIG. 3, on one side surface of the printer frame 3, there is a shaft insertion hole 24 for insertion of the knob shaft 16 slidably in the axial and rotational directions, a rod insertion hole 25 for insertion of the selector wheel rotation restricting rod 20 slidably in the axial direction, and a frame insertion hole 26 for insertion of the display frame 21 slidably in the axial direction are formed.

The selector wheel rotation restricting rod 20 extends across in the axial direction of the selector wheels 6 on the printer frame 3, and is supported by the axial direction operation of the operation member 5 so that it appears and disappears at the rod insertion hole 25. At the upper portion restricting portion 20A located at the upper portion of the selector wheel rotation restricting rod 20, there is a rotation allowing recess 20B located at the position of the drive projection 18 of the knob shaft 16 which enables rotation only of the selected selector wheel 6 by the operating member 5 out of all of the selector wheels 6. A rotation restricting projection 20C enables restriction on rotation of the unselected selector wheels 6.

The rotation allowing recess 20B, particularly as shown in FIG. 2, occupies from nearly one to less than two selector wheels 6 in thickness in the axial direction at the upper portion restricting portion 20A. The rotation restricting projection 20C occupies the majority of the upper portion restricting portion 20A, and the projection 20C is capable of engaging simultaneously in the outer engaging grooves 6B of the plural number of selector wheels 6 (to be more precise, the number of selector wheels 6 subtracting one from the number of selector wheels 6 provided at the printer 1).

The display frame 21 extends across in the axial direction of the selector wheels 6 on the printer frame 3, is supported by the axial direction operation of the operation member 5, and appears and disappears at the frame insertion hole 26. Particularly as shown in FIG. 2, the display frame 21 is provided with a long rectangular display character window 21A where the entire row of plural number of selector wheels 6 can be seen. Also on the display frame 21, a print matching arrow 21B indicates a row of the selector wheel 6 which is located at a portion of the display character window 21A that is at the drive projection 18 of the knob shaft 16. The arrow 21B protrudes inwardly of the display character window 21A.

The selector wheels 6 are located inside the endless print bands 8 and the bands are linable in plural rows (in five rows in the shown example). The printer 1 can perform five-column printing by the five rows of endless print bands 8.

The print pressure bearing base-regulating blocks 7, as shown in FIGS. 1 and 2, are provided at the five rows together with the selector wheels 6 and the endless print bands 8. The print pressure bearing base-regulating blocks 7 are square-shaped in cross-section and are rotatable around a print pressure bearing pin 27 that extends across the print frame 3. The blocks 7 are formed with band engaging grooves 7A on each side.

The print pressure bearing base-regulating blocks 7 are urged by a regulating pressing member 28 and a spring for the block 29 in a manner such that the member 28 is capable of restricting the rotation, and together with the print character selector 2, obtaining rotation regulation during rotation of the selector wheels 6, that is, rotation of the endless print bands 8, by the operating member 5.

The endless print band 8 is formed with a plurality of print characters 8A and with display characters 8B corresponding to these print characters 8A around its outer periphery. The characters are each formed at separate regions on the outer periphery of the band 8. The endless print band 8 is formed around its inner periphery with drive projections 8C each engaging with the outer peripheral engaging grooves 6B of the selector wheel 6 and band engaging grooves 7A of print pressure bearing base-regulating block 7.

As shown in FIG. 1, the print characters 8A are able to contact the ink roller R at the ink roller access opening 13 located at the lower portion of the printer 1. The display characters 8B corresponding to the print characters 8A can be seen at the display window 12 located at the upper portion.

In addition, between adjacent selector wheels 6 (endless print bands 8), laminar divider plates (not shown) are arranged to prevent the selector wheels 6 next to each other rotating together when a particular selector wheel 6 (endless print band 8) is selected.

As shown in FIGS. 3 and 6, the printer frame 3 is formed with an urging member setting hole 30 on one side surface of the printer frame 3 adjacent to the knob 15 and that intersects the shaft insertion hole 24.

The urging member setting hole 30 includes an entrance portion 30A which opens toward one side surface of the printer frame 3 and the shaft insertion hole 24, and includes a setting portion 30B facing the entrance portion 30A across the shaft insertion hole 24 and having a bottom opened towards the shaft insertion hole 24.

The coil spring for regulation 10 and the steel ball 11 at the setting portion 30B are set over the shaft insertion hole 24 from the entrance portion 30A.

The steel ball 11 is capable of engaging and disengaging from each regulating recesses 16A under the urging force (regulating force) of the coil spring for regulation 10.

A method of assembling the operating member 5 of the print character selector 2 of a configured printer 1 and print character selector 2 is now explained.

Into the entrance portion 30A of the urging member setting hole 30 formed on the printer frame 3 located at the upper side, first, the urging members for regulation 9 are dropped, then the coil spring for regulation 10 and then the steel ball 11 are installed (the urging member setting process).

Next, the knob shaft 16 is inserted into the shaft insertion hole 24 on the printer frame 3 from the assembling end 23 side (from right-to-left in FIG. 6) such that the steel ball 11 is engageable with and disengageable from the regulating recesses 16A (the shaft insertion process).

Next, with the assembling end 23 of the knob shaft 16 protruding out to the outside of the printer frame 3, the indicator 17 is assembled by inserting the selector wheel rotation restricting rod 20 into the rod insertion hole 25 of the printer frame 3 from left-to-right towards the assembling end 23 in FIG. 6, such that the assembling end 23 is inserted into the shaft through-hole 22. The display frame 21 is inserted into the frame insertion hole 26 (the indicator assembling process).

Finally, the knob 15 is assembled from left-to right in FIG. 6, such that the assembling end 23 of the knob shaft 16 is inserted into the shaft attachment hole 15A (the knob assembling process).

By this assembly process, the engaging projection 23A of the assembling end 23 is engaged with the step portion for axial direction fixing 15B and the key way 15C of the knob 15, attaching the indicator 17 to the assembling end 23, enabling transmission of the rotational operation of the knob 15 to the knob shaft 16 by the engagement of the key way 15C of the knob 15 with the engaging projection 23A of the assembling end 23.

Thus, in each of the above processes, when assembling the urging member for regulation 9, with the knob shaft 16, the indicator 17, and also the knob 15 in that order, a special positioning, etc. is not required for the each part, thereby improving the assembling work efficiency.

Furthermore, the urging member setting hole 30 can keep the entrance part 30A in an open state. Therefore, it is not required to close the opening by a screw or with a hole cap as in the past.

In addition, each necessary part such as the selector wheels 6 and the endless print bands 8 is assembled to the knob shaft 16 of the operating member 5 assembled as explained above.

Next, the selecting operation of a desired print character 8A at a desired row is explained.

Particularly as shown in FIG. 2, rotation-selecting the print character 8A of the endless print band 8 after selecting the selector wheel 6 (endless print band 8) on the row at the innermost side (the right side in FIG. 2) from the knob 15 is described. It is possible to perform the selection operation of the row (that is, indexing operation) by setting the drive projection 18 of the knob shaft 16 at the corresponding inner peripheral engaging groove 6A of the selector wheel 6 by pushing the knob 15 of the operating member 5 to the innermost portion in the axial direction of the selector wheel 6, and by setting the print matching arrow of the display frame 21 to this row. In addition, since the inner peripheral engaging grooves 6A of each selector wheel 6 are aligned in the axial direction, the drive projection 18 has no problem moving in the axial direction.

Furthermore, since the regulating recesses 16A of the knob shaft 16 engage and disengage from the steel ball 11 of the urging member for regulation 9, the operator can directly feel the axial direction regulation from the knob 15 (knob shaft 16).

At the selected row, since the above drive projection 18 opposes the rotation allowing recess 20B of the selector wheel rotation restricting rod 20, the knob 15 (knob shaft 16) is rotatable. Therefore, the selected selector wheel 6 is rotated by the drive projection 18 to rotate the endless print band 8.

At rotation, the selector wheels 6, other than the selected selector wheel 6, 6 will not rotate since their outer peripheral groove 6B are all engaged to the rotation restricting projection 20C of the selector wheel rotation restricting rod 20.

Furthermore, as the regulating recesses 6A of the knob shaft 16 engage and disengage from the steel ball 11 of the urging member for regulation 9 in the rotational direction, the operator can directly feel the rotational direction regulation from the knob 15 (knob shaft 16).

In addition, since at rotation, the required numbers of the print pressure bearing base-regulating blocks 7 also rotate, the desired print character 8A can be opposed to the ink roller R.

It is the same in case of selecting the selector wheel 6 (endless print band 8) of the other row.

1. A print character selector of a printer comprising:
a printer having a printer frame;
selector wheels lying side by side and overlapping coaxially with each other along an axis, each wheel being rotatable around an axis at the printer frame; the selector wheels having inner and outer peripheral engaging grooves;
an operating member configured to select any one of the selector wheels along the axis and the operating member is configured to rotationally drive any selected selector wheel around the axis;
a plurality of endless print bands, each band having a periphery, each band formed with a plurality of print characters on the periphery of the band, and each band is engaged with the outer peripheral engaging grooves of the selector wheels,
the print character selector comprising:
a sleeve supporting the selector wheels rotatably, and the sleeve forming a selection window extending in the axial direction;
the operating member having:
a knob movable along the axial direction of the selector wheels and rotatable around the axis;
a knob shaft operable by the knob in a reciprocating and a rotatable manner inside the sleeve, drive projections on the knob shaft capable of rotationally driving each of the selector wheels by engaging the inner peripheral engaging grooves of the selector wheels through the selection window of the sleeve;
a plurality of regulating recesses in the knob shaft, each of the recesses being associated with a respective one of the selector wheels and with a rotative position of the respective selector wheel, a selected recess being selected by moving the knob shaft along the axial direction, and a selected print character on a selector wheel is selected by rotating the knob shaft around the axis; and
an urging member for regulation provided on the printer frame and engageable with and disengagable from the regulating recesses.

2. The print character selector of a printer according to claim 1, wherein the regulating recesses of the knob shaft are formed at positions corresponding to the selector wheels, and along the rotating direction of the selector wheels.

3. The print character selector of a printer according to claim 1, wherein the urging members for regulation are each a coil spring and a ball which are set inside an urging member setting hole formed on the printer frame adjacent to the knob shaft, and the ball is capable of engaging and disengaging from each of the regulating recesses.

4. The print character selector of a printer according to claim 1, wherein the operating member has a display frame configured for moving with the knob shaft in an integrated manner in the axial direction of the selector wheels, and extending in the axial direction.

5. The print character selector of a printer according to claim 1, wherein the operating member is provided with a selector wheel rotation restricting rod configured for moving with the knob shaft in an integrated manner in the axial direction of the selector wheels, and extending in the axial direction;
the selector wheel rotation restricting rod having a rotation allowing recess shaped and placed to enable only the selector wheel selected out of the selector wheels by the operation member to rotate, and a rotation restricting projection shaped and placed to enable rotation of the unselected selector wheels to be restricted.

6. The print character selector of a printer according to claim 5, wherein the rotation restricting projection of the selector wheel rotation restricting rod is engageable with outer peripheral engaging grooves of the selector wheels.

7. A method of assembling operating member of a print character selector of a printer comprising:
a printer having a printer frame;
selector wheels lying side by side and overlapping coaxially with each other along an axis, each wheel being rotatable around an axis at the printer frame; the selector wheels having inner and outer peripheral engaging grooves;
an operating member configured to select any one of the selector wheels along the axis and the operating member is configured to rotationally drive any selected selector wheel around the axis;
a plurality of endless print bands, each band having a periphery, each band formed with a plurality of print characters on the periphery of the band, and each band is engaged with the outer peripheral engaging grooves of the selector wheels,
the operating member having:
a knob capable of moving operation along the axial direction of the selector wheels and rotating operation around the axial direction;
a knob shaft operable by the knob and provided with driving projections engaging to the inner peripheral grooves of the selector wheels enabling to rotationally drive the selector wheels;
a display frame capable of moving with the knob shaft in an integrated manner in the axial direction of the selector wheel, and extending in the axial direction;
a selector wheel rotation restricting rod capable of moving with the knob shaft in an integrated manner in the axial direction of the selector wheel, and extending in the axial direction;
the knob shaft formed with a plurality of regulating recesses and configured for selecting any one of the selector wheels by moving the knob along the axial direction and configured for selecting any one of the print characters by rotating the knob around the axial direction; and,
an indicator formed by integrating the display frame and the selector wheel rotation restricting rod; and,
the method of assembling operating member of a print character selector of a printer including:
an urging member setting process which sets an urging member for regulation to an urging member setting hole formed on the printer framed adjacent to the knob;
a shaft inserting process which inserts the knob shaft into a shaft attachment hole on the printer frame such that the urging member for regulation is engageable with and disengageable from the regulating recesses;
an indicator assembling process which assembles the indicator to an assembling end of the knob shaft; and
a knob assembling process which assembles the knob to the assembling end of the knob shaft.

8. A method of assembling operating member of a print character selector of a printer according to claim 7, wherein the urging member setting hole and the shaft attachment through-hole are formed in a manner crossing each other.
